(19) United States
(12) Patent Application Publication
(10) Pub. No.: US 2019/0326026 A1
(43) Pub. Date: Oct. 24, 2019

(54) NUCLEAR POWER PLANT HAVING IMPROVED COOLING PERFORMANCE AND METHOD FOR OPERATING SAME

(71) Applicant: KOREA HYDRO & NUCLEAR POWER CO., LTD, Gyeongsangbuk-do (KR)

(72) Inventors: Han Gon KIM, Daejeon (KR); Sang Won LEE, Daejeon (KR); Sun HEO, Daejeon (KR); Hui Un HA, Daejeon (KR)

(21) Appl. No.: 16/475,034

(22) PCT Filed: Jan. 2, 2018
(86) PCT No.: PCT/KR2018/000003

§ 371 Date: Jun. 28, 2019

(30) Foreign Application Priority Data
Jan. 3, 2017 (KR) 10-2017-0000816
Nov. 9, 2017 (KR) 10-2017-0148805

(51) Int. Cl. G21C 15/18

(52) U.S. Cl. CPC G21C 15/182; G21C 15/185

(57) ABSTRACT

The present invention relates to a nuclear power plant having improved cooling performance and a method for operating the same. The nuclear power plant having improved cooling performance according to the present invention comprises: a reactor vessel including a reactor core; a hot-leg and a cold-leg extending from the reactor vessel; a hybrid safety injection tank which contains coolant, is connected to the cold-leg and the reactor vessel, and is positioned higher than the reactor core; a coolant tank connected to the reactor vessel and positioned higher than the reactor core; and a pressure reducing valve connected to the hot-leg.

### TECHNICAL FIELD

The present invention relates to a nuclear power plant with improved cooling performance and a method of operating the same.

### BACKGROUND ART

An active emergency core cooling system of the nuclear power plant is configured to have a pump (high pressure injection pump, low pressure injection pump, etc.), accumulator (safety injection tank, etc.) and a coolant tank. When a normal heat removal through steam generators and turbines is not available, the active emergency core cooling system injects directly emergency coolant into the reactor coolant system (hot-leg or cold-leg, reactor vessel) to cool the reactor core.

A safety injection tank employs a safety injection tank containing a pressurized gas. When the pressure of the reactor vessel becomes lower than the pressure of the safety injection tank, the safety injection tank supplies the coolant therein to the nuclear reactor. However, when the pressure of the reactor vessel and/or the reactor coolant system is higher than the pressure of the safety injection tank, there is a problem that the coolant of the safety injection tank may not be supplied to the reactor vessel and/or the reactor coolant system.

Further, the pump of the active emergency core cooling system supplies the coolant of the coolant tank to the reactor vessel using the driving force from a motor. Thus, there is a problem that the pump cannot be used when there is no power (AC power).

### DISCLOSURE

### Technical Problem

A purpose of the present invention is therefore to provide a nuclear power plant with improved cooling performance and a method of operating the same.

### Technical Solution

In one aspect, there is proposed a nuclear power plant with improved cooling performance, the plant comprising: a reactor vessel containing a reactor core; a hot-leg and a cold-leg extending from the nuclear reactor; a hybrid safety injection tank for containing coolant therein, wherein the hybrid safety injection tank is connected to the cold-leg and the nuclear reactor, and the hybrid safety injection tank is located above the nuclear reactor; a coolant tank connected to the reactor vessel and positioned above the nuclear reactor; and a pressure-reducing valve connected to the high-temperature pipe.

In one embodiment, the nuclear power plant further comprises a regulating valve located between the hybrid safety injection tank and the low-temperature pipe.

In one embodiment, the reactor vessel further comprises a downcomer, wherein the coolant of the hybrid safety injection tank is supplied to the downcomer.

In one embodiment, the coolant of the hybrid safety injection tank is supplied to a lateral face of the nuclear reactor.

In one embodiment, the nuclear power plant further comprises: a steam generator connected to the high-temperature pipe and the low-temperature pipe; a pressurizer connected to the high-temperature pipe; and a pressure relief valve connected to the pressurizer, wherein the hybrid safety injection tank is not affected by a pressure change resulting from operation of the pressure relief valve.

In one embodiment, the coolant of the hybrid safety injection tank is pressurized by pressurized gas, wherein the coolant of the coolant tank is supplied to a lateral face of the nuclear reactor.

In one embodiment, the nuclear power plant further comprises a safety injection tank containing a coolant and connected to the reactor vessel and positioned above the nuclear reactor, wherein the safety injection tank is pressurized by a pressurizing gas.

In one embodiment, the nuclear power plant further comprises a heat-exchanger to condense vapor inside a reactor building, wherein condensed water produced in the heat exchanger is supplied to the coolant tank.

In another aspect, there is proposed a nuclear power plant with improved cooling performance, the plant comprising: a reactor vessel containing a reactor core; a hot-leg and a cold-leg extending from the nuclear reactor; a hybrid safety injection tank for containing coolant therein, wherein the hybrid safety injection tank is connected to the cold-leg and the nuclear reactor, and the hybrid safety injection tank is located above the nuclear reactor; a coolant tank connected to the reactor vessel and positioned above the nuclear reactor; a pressurizer connected to the high-temperature pipe; and a pressure-reducing valve connected to the high-temperature pipe, wherein when the hybrid safety injection tank communicates with the low-temperature pipe, the hybrid safety injection tank supplies the coolant to the reactor vessel due to a water head differential, wherein the coolant supply from the hybrid safety injection tank is not affected by a pressure change of the pressurizer.

In still another aspect, there is proposed a method for operating a nuclear power plant with improved cooling performance, wherein the plant comprises: a reactor vessel containing a reactor core; a hot-leg and a cold-leg extending from the nuclear reactor; a hybrid safety injection tank for containing coolant therein, wherein the hybrid safety injection tank is connected to the cold-leg and the nuclear reactor, and the hybrid safety injection tank is located above the nuclear reactor; a coolant tank connected to the reactor vessel and positioned above the nuclear reactor; and a pressure-reducing valve connected to the high-temperature pipe, wherein the method comprises:

equalizing a pressure of the reactor vessel with a pressure of the hybrid safety injection tank in an emergency event, thereby to supply the coolant of the hybrid safety injection tank to the reactor vessel using a water head differential; and reducing the pressure of the reactor vessel to an atmospheric pressure by opening the pressure-reducing valve, thereby to supply the coolant of the coolant tank to the reactor vessel using a water head differential.

In one embodiment, the nuclear power plant further comprises a regulating valve located between the hybrid safety injection tank and the low-temperature pipe, wherein the pressure of the hybrid safety injection tank and the reactor vessel is equalized to each other by opening the regulating valve.

In one embodiment, the nuclear power plant further comprises: a steam generator connected to the high-temperature pipe and the low-temperature pipe; a pressurizer connected to the high-temperature pipe; and a pressure relief valve connected to the pressurizer, wherein the hybrid safety injection tank is not affected by a pressure change resulting from operation of the pressure relief valve.

In one embodiment, the method further comprises, after supplying the coolant of the hybrid safety injection tank to the nuclear reactor, lowering a pressure of the high-pressure pipe by opening the pressure relief valve.

### Advantageous Effects

In accordance with the present invention, the nuclear power plant with improved cooling performance and the method of operating the same may be realized.

### DESCRIPTION OF DRAWINGS

FIG. 1 shows a nuclear power plant according to one embodiment of the present invention.

FIG. 2 to FIG. 4 illustrate operation of a nuclear power plant according to one embodiment of the present invention.

### MODE FOR INVENTION

The present invention will now be described in more detail with reference to the drawings.

The accompanying drawings are merely illustrative examples for the purpose of more specifically describing the technical idea of the present invention, and thus the idea of the present invention is not limited to the accompanying drawings. Further, the accompanying drawings may be exaggerated in size and spacing in order to describe the relationship between components.

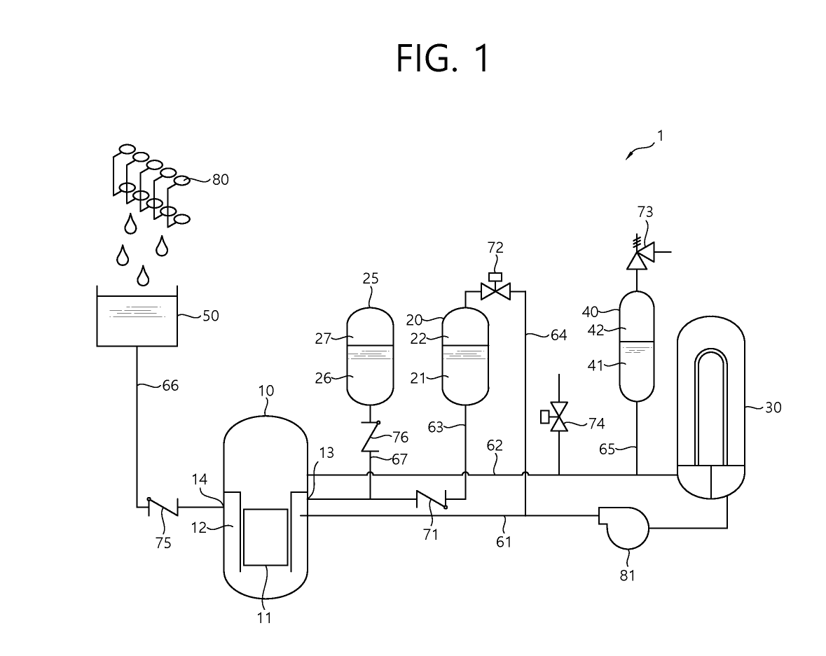

FIG. 1 shows a nuclear power plant according to one embodiment of the present invention.

The nuclear power plant 1 comprises a reactor vessel 10, a hybrid safety injection tank 20, a safety injection tank 25, a steam generator 30, a pressurizer 40, a coolant tank 50 and a heat-exchanger 80. In addition, the nuclear power plant 1 comprises cold-leg 61, hot-leg 62, various pipes 63 to 67, and various valves 71 to 76.

The reactor vessel 10 comprises a reactor core 11, a downcomer 12, and coolant injection portions 13 and 14. The coolant injection portions 13 and 14 are located on the side wall of the reactor vessel 10 and communicate with the downcomer 12.

In a normal operation mode, heated pressurized coolant(coolant water) produced in the reactor vessel 10 is discharged to the high-temperature pipe 62 and then is heat-exchanged in the steam generator 30 to generate steam, and then returned to the reactor vessel 10 through the cold-leg 61.

The pressurizer 40 is connected to the high-temperature pipe 62 via a pipe 65 and controls the system pressure during a nuclear power plant operation. The space within the pressurizer 40 may be divided into a lower space 41 and an upper space 42. The lower space 41 may contain coolant and the upper space 42 may contain steam. A pressure relief valve 73 is located above the pressurizer 40. When the reactor coolant system is pressurized above the operation pressure, the pressure-relief valve 73 is automatically opened to prevent damage to the coolant system. Opening the pressure relief valve 73 may allow fluid to be released to the outside such that the pressure of the coolant system is lowered.

The high-temperature pipe 62 is connected to a pressure-reducing valve 74. When the pressure-reducing valve 74 is opened, the pressure of the high-temperature pipe 62 is reduced.

The hybrid safety injection tank 20 is located above the reactor vessel 10. The top of the hybrid safety injection tank 20 is connected to the cold-leg 61 through a pipe 64. The bottom of the hybrid safety injection tank 20 is connected to the coolant injection portion 13 through a pipe 63.

The lower space 21 of the hybrid safety injection tank 20 is filled with coolant and its upper space 22 is filled with pressurizing gas. The pressure of the pressurizing gas in the hybrid safety injection tank 20 may be in a range of 40 to 100 atm. The pressurizing gas may be nitrogen gas and the coolant may contain boric acid.

A check valve 71 is located on the pipe 63 between the hybrid safety injection tank 20 and the reactor vessel 10. The flow of coolant from the reactor vessel 10 to the hybrid safety injection tank 20 is limited by the check valve 71.

On the pipe 64 connecting the hybrid safety injection tank 20 and the cold-leg 61, an adjustment valve 72 is located. The regulating valve 72 remains closed during a normal operation. At this time, when the pressure of the reactor vessel 10 is lower than the pressure of the hybrid safety injection tank 20, the coolant of the hybrid safety injection tank 20 is supplied to the reactor vessel 10.

The safety injection tank 25 is located above the reactor vessel 10. The bottom of the safety injection tank 25 is connected to the coolant injection portion 13 through a pipe 67.

The lower space 26 of the safety injection tank 25 is filled with coolant and its upper space 27 is filled with pressurizing gas. The pressure of the pressurizing gas in the safety injection tank 25 may be in a range of 40 to 100 atm. The pressurizing gas may be nitrogen gas and the coolant may contain boric acid.

The check valve 76 is located on the pipe 67 between the safety injection tank 25 and the reactor vessel 10. The coolant flow in the direction from the reactor vessel 10 to the safety injection tank 25 is limited by the check valve 76.

The coolant tank 50 is at atmospheric pressure and is located higher than the reactor vessel 10. The coolant tank 50 is connected to the reactor vessel 10 through a pipe 66. Specifically, the coolant in the tank 50 is supplied to the downcomer 12 through the coolant injection portion 14 of the reactor vessel 10. A check valve 75 is provided on the pipe 66 connecting the reactor vessel 10 and the coolant tank 50 to prevent coolant flow in the direction of the coolant tank 50 from the reactor vessel 10. The coolant injection portions 13 and 14 connected to the hybrid safety injection tank 20 and the coolant tank 50 may be the same injection portion or individual injection portions.

The heat-exchanger 80 is located above the reactor vessel 10 and condenses the vapor generated in the reactor building. The heat-exchanger 80 may be installed on the inner wall of a reactor building or may discharge the heat outside the reactor building.

The coolant, which is condensed and generated in the heat-exchanger 80, is fed to the coolant tank 50.

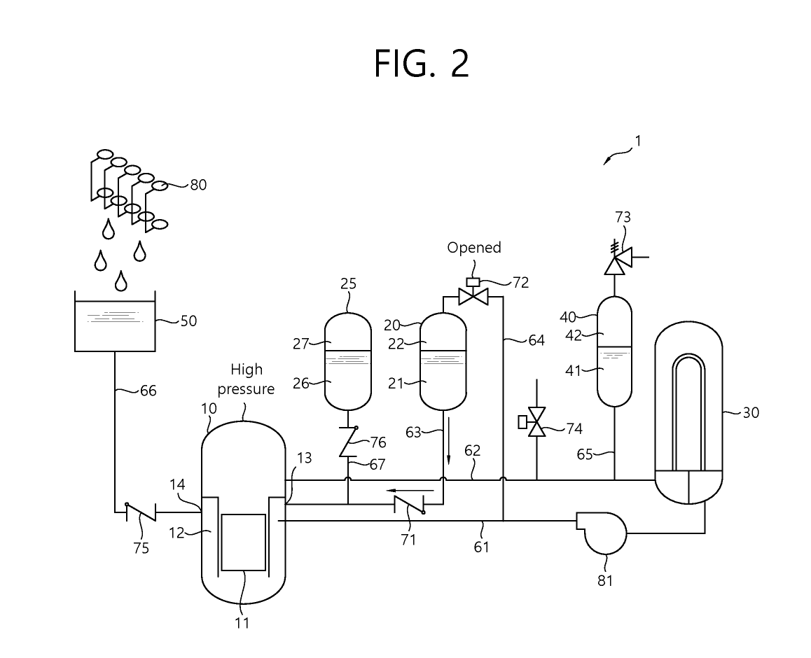

Hereinafter, an operation method of a nuclear power plant according to one embodiment of the present invention will be described with reference to FIG. 2 to FIG. 4.

Due to an accident, a situation occurs in which the coolant of the hybrid safety injection tank 20, safety injection tank 25, and coolant tank 50 must be supplied to the reactor vessel 10 in the state where the reactor vessel 10 maintains the high pressure.

According to the present invention, in this case, the method first opens the regulating valve 72 as shown in FIG. 2. When the regulating valve 72 is opened, the cold-leg 61 and the hybrid safety injection tank 20 are communicated with each other such that the hybrid safety injection tank 20 is further pressurized. Thus, the cold-leg 61 and the hybrid safety injection tank 20 have the same pressure. Further, the reactor vessel 10 is thus at the same pressure as that of the hybrid safety injection tank 20.

When the reactor vessel 10 and the hybrid safety injection tank 20 are at the same pressure, the coolant of the hybrid safety injection tank 20 is supplied to the reactor vessel 10 due to the water head differential. The coolant of the hybrid safety injection tank 20 is supplied to the downcomer 12 through the coolant injection portion 13 provided on the side wall of the reactor vessel 10.

The regulating valve 72 may be opened by manipulation of operator or by automatic operation. For this purpose, a battery may be installed and used if necessary.

As described above, in accordance with the present invention, the hybrid safety injection tank 20 is connected to the cold-leg 61. When the hybrid safety injection tank 20 is connected to the pressurizer 40, the pressure of the hybrid safety injection tank 20 may be reduced in an emergency event by opening the pressure-relief valve 73. This problem does not occur when the hybrid safety injection tank 20 is connected to the cold-leg 61 in accordance with the present invention. That is, the hybrid safety injection tank 20 according to the present invention is not affected by the operation of the pressure relief valve 73 at the emergency injection timing.

Further, even when the hybrid safety injection tank 20 is connected to the high-temperature pipe 62, the pressure of the hybrid safety injection tank 20 may be reduced in an emergency event by opening the pressure-relief valve 73. However, since the pressure change of the cold-leg 61 due to the operation of the pressure-relief valve 73 is not large, the pipe 61 can supply coolant efficiently in an emergency event.

In the nuclear power plant, only one pressurizer 40 is installed, whereas each of the cold-leg 61, the high-temperature pipe 62 and the hybrid safety injection tank 20 may be provided in a plural manner. Thus, connecting a plurality of hybrid safety injection tanks 20 to a single pressurizer 40 results in a long and complicated pipe structure. According to the present invention, each hybrid safety injection tank 20 is connected to an adjacent cold-leg 61, the pipe is short and simple, and the shapes of the pipes may be the same.

As described above, after the supply of the coolant of the hybrid safety injection tank 20, and when further cooling is required, the coolant of the coolant tank 50 is supplied to the reactor vessel 10.

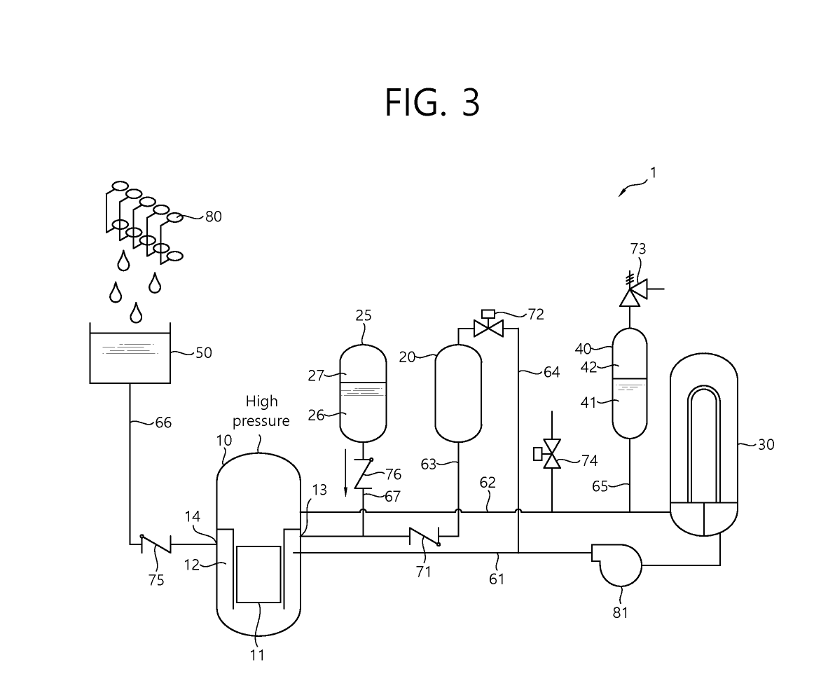

Next, as shown in FIG. 3, when the pressure of the reactor vessel 10 is lowered to be lower than the pressurizing gas of the safety injection tank 25, the check valve 76 is opened. Accordingly, the coolant of the safety injection tank 25 is supplied to the reactor vessel 10. In another embodiment, pressure reduction of the reactor vessel 10 through the opening of the pressure relief valve 73 may be required to provide the coolant of the safety injection tank 25.

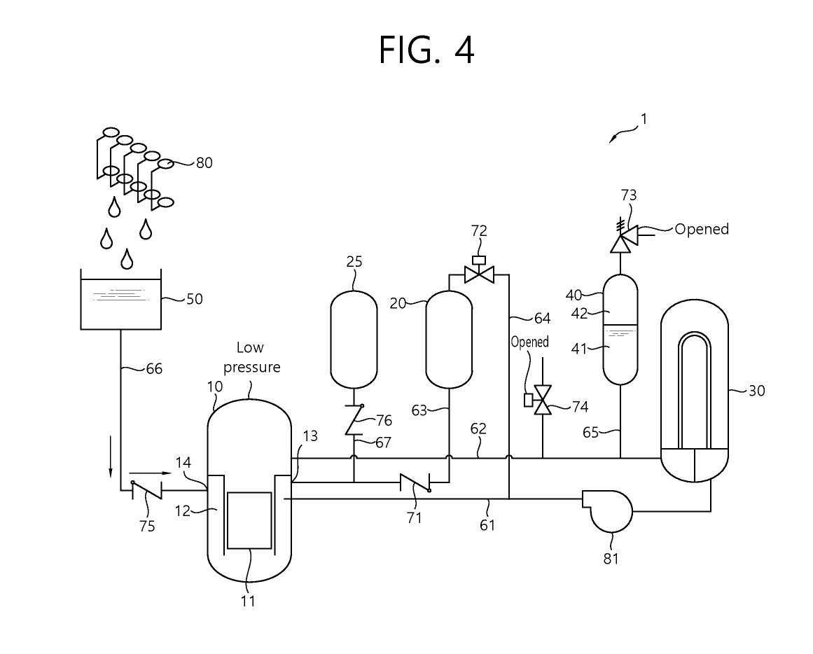

Then, the method opens the pressure relief valve 73 and the pressure-reducing valve 74 as shown in FIG. 4 to supply the coolant of the coolant tank 50. The opening order of the pressure relief valve 73 and the pressure-reducing valve 74 is not limited to a specific order. In one example, and the opening operations thereof may occur simultaneously.

The opening of the pressure relief valve 73 and the pressure-reducing valve 74 may be accomplished by manipulation of operator or by automatic operation. For this purpose, a battery may be installed and used if necessary.

By opening the pressure relief valve 73 and the pressure-reducing valve 74, the pressure of the pressurizer 40 and the high-temperature pipe 62 becomes close to the atmospheric pressure so that the pressure of the reactor vessel 10 becomes close to the atmospheric pressure. The pressure-reducing valve 74 is characterized by a larger effective releasing area than those of the pressure relief valve 73 and pressurizer connection pipe 65. Thus, the operation of the pressure-reducing valve 74 causes a rapid pressure drop in the reactor vessel 10. The pressure-reducing valve 74 may be installed on at least one high-temperature pipe.

In this situation, the coolant of the coolant tank 50 is supplied to the reactor vessel 10 due to the water head differential. In an emergency event, the temperature of the upper portion of the reactor vessel 10 is the highest. According to the present invention, the coolant is supplied through the side portion of the reactor vessel 10 to increase the reactor core cooling capacity.

The discharged steam through the leakage points of the cold-leg 61 and the hot-leg 62, and the valves 73 and 74 condenses on the cold surface of the heat-exchanger 80. The condensed condensate is collected in the coolant tank 50. The heat-exchanger 80 discharges the heat inside the reactor building out of the building, thereby reducing the temperature and pressure inside the reactor building.

Since the coolant supply from the coolant tank 50 as described above is performed without the operation of pump, the coolant may be supplied when the power (AC power) is interrupted.

The embodiments as described above are illustrative of the present invention, and the present invention is not limited thereto. It will be understood by those skilled in the art that various changes in form and details may be made therein without departing from the spirit and scope of the present invention as defined by the appended claims.

1. A nuclear power plant with improved cooling performance, the plant comprising:
a reactor vessel containing a reactor core;
a hot-leg and a cold-leg extending from the reactor vessel;
a hybrid safety injection tank for containing coolant therein, wherein the hybrid safety injection tank is connected to the cold-leg and the reactor vessel, and the hybrid safety injection tank is are located above the reactor core;
a coolant tank connected to the reactor vessel and positioned above the reactor core; and
a pressure-reducing valve connected to the hot-leg.

2. The nuclear power plant of claim 1, wherein the nuclear power plant further comprises a regulating valve located between the hybrid safety injection tank and the cold-leg.

3. The nuclear power plant of claim 2, wherein the reactor vessel further comprises a downcomer, wherein the coolant of the hybrid safety injection tank is supplied to the downcomer.

4. The nuclear power plant of claim 1, wherein the coolant of the hybrid safety injection tank is supplied to a lateral face of the reactor core.

5. The nuclear power plant of claim 2, wherein the nuclear power plant further comprises:
a steam generator connected to the high-temperature pipe and the low-temperature pipe;
a pressurizer connected to the hot-leg; and
a pressure relief valve connected to the pressurizer,
wherein the hybrid safety injection tank is not affected by a pressure change resulting from operation of the pressure relief valves.

6. The nuclear power plant of claim 5, wherein the coolant of the hybrid safety injection tank is pressurized by gas, wherein the coolant of the coolant tank is supplied to a lateral face of the reactor core.

7. The nuclear power plant of claim 1, wherein the nuclear power plant further comprises a safety injection tank containing a coolant and connected to the reactor vessel and positioned above the reactor core, wherein the safety injection tank is pressurized by gas.

8. The nuclear power plant of claim 1, wherein the nuclear power plant further comprises a heat-exchanger to condense vapor inside a reactor building, wherein condensed water produced in the heat exchanger is supplied to the coolant tank.

9. A nuclear power plant with improved cooling performance, the plant comprising:
a reactor vessel containing a reactor core;
a hot-leg and a cold-leg extending from the reactor vessel;
a hybrid safety injection tank for containing coolant therein, wherein the hybrid safety injection tank is connected to the cold-leg and the nuclear reactor, and the hybrid safety injection tank is located above the reactor core;
a coolant tank connected to the nuclear reactor vessel and positioned above the reactor vessel;
a pressurizer connected to the hot-leg; and
a pressure-reducing valve connected to the hot-leg,
wherein when the hybrid safety injection tank communicates with the cold-leg, the hybrid safety injection tank supplies the coolant to the reactor vessel due to a water head differential,
wherein the coolant supply from the hybrid safety injection tank is not affected by a pressure change of the pressurizer.

10. A method for operating a nuclear power plant with improved cooling performance, wherein the plant comprises:
a reactor vessel containing a reactor core;
a hot-leg and a cold-leg extending from the reactor vessel;
hybrid safety injection tank for containing coolant therein, wherein the hybrid safety injection tank is connected to the cold-leg and the reactor vessel, and the hybrid safety injection tank is located above the reactor core;
a coolant tank connected to the reactor vessel and positioned above the reactor vessel;
a pressurizer connected to the hot-leg,
wherein the method comprises:
equalizing a pressure of the reactor vessel with a pressure of the hybrid safety injection tank in an emergency event, thereby to supply the coolant of the hybrid safety injection tank to the reactor vessel using a water head differential; and
reducing the pressure of the reactor vessel to an atmospheric pressure by opening the pressure-reducing valve, thereby to supply the coolant of the coolant tank to the reactor vessel using a water head differential.

11. The method of claim 10, wherein the plant further comprises regulating valves located between the hybrid safety injection tank and the cold-leg,
wherein the pressure of the hybrid safety injection tank and the reactor vessel are equalized to each other by opening the regulating valve.

12. The method of claim 10, wherein the nuclear power plant further comprises:
a steam generator connected to the high-temperature pipe and the low-temperature pipe;
a pressurizer connected to the high-temperature pipe; and
a pressure relief valve connected to the pressurizer,
wherein the hybrid safety injection tank is not affected by a pressure change resulting from operation of the pressure relief valve.

13. The method of claim 11, wherein the method further comprises, after supplying the coolant of the hybrid safety injection tank to the reactor vessel, lowering pressure of the hot-leg by opening the pressure relief valve.
